(19) United States
(12) Patent Application Publication
(10) Pub. No.: US 2013/0306889 A1
(43) Pub. Date: Nov. 21, 2013

(54) SWITCHING FITTING ARRANGEMENT

(71) Applicant: Robert Bosch GmbH, Stuttgart (DE)

(72) Inventors: Udo Froehlich, Rothenfels (DE); Richard Tauber, Heigenbruecken (DE)

(73) Assignee: Robert Bosch GmbH, Stuttgart (DE)

(21) Appl. No.: 13/894,672

(22) Filed: May 15, 2013

(30) Foreign Application Priority Data
May 15, 2012 (DE) 10 2012 009 732.8

(51) Int. Cl. F16K 31/56

(52) U.S. Cl. CPC F16K 31/56
USPC 251/69

(57) ABSTRACT

A switching fitting arrangement includes two switching fittings actuated by a switching drive. A switching drive is implemented with an additional energy accumulator, for example a part stroke spring, which permits a part stroke test.

This application claims priority under 35 U.S.C. § 119 to patent application no. DE 10 2012 009 732.8, filed on May 15, 2012 in Germany, the disclosure of which is incorporated herein by reference in its entirety.

### BACKGROUND

The disclosure relates to a switching fitting arrangement for controlling process flows.

EP 1 413 810 A1 discloses a switching fitting arrangement of the type in question for a turbine valve for controlling the supply of gas or steam to a turbine or for a process fitting for controlling a process flow in process engineering. Switching fitting arrangements of this type customarily have an actuator which, in the case of the subject matter of EP 1 413 810 A1, is implemented in the form of an electric spindle drive. In the case of a gas turbine, an opening cross section of a fitting can be adjusted, for example by means of an adjusting arrangement of this type, in order to set a supply of gas. In an emergency, for example in the case of a power failure or a malfunction, the fitting is intended to be reset automatically in order to avoid damage to the installation. For this purpose, in the known solution, the spindle drive is assigned a toggle lever mechanism which is locked in an extended position, in which a prestressing spring is tensioned, during regular operation, i.e. when sufficient power is supplied. In the event of a power failure, the locking mechanism releases the toggle lever such that the latter is adjusted from the extended position thereof into the bent position thereof via the prestressing spring and the fitting is set back into the predetermined basic position, as a rule the closed position, according to said adjustment displacement.

DE 10 2009 021 668 A1 belonging to the applicant discloses an arrangement in which a fitting is actuated via a regulating drive and a switching fitting arranged in series with said fitting is actuated via a switching drive. The regulating drive is designed with an emergency actuation which closes the fitting in the event of a power failure. In contrast to the previously described exemplary embodiment, this emergency actuation is not formed by a toggle lever mechanism but rather by a spring which acts in the closing direction on the fitting and which is hydraulically pretensioned. In the event of the emergency actuation, said prestressing pressure is reduced down to the low pressure such that the spring shuts the regulating fitting. In a corresponding manner, the switching fitting is also closed in the event of a power failure, and therefore damage to the turbine or to the process engineering installation is virtually ruled out. In this known solution, an electrically actuable fitting valve is arranged in a relief path to the low pressure, said fitting valve being prestressed in the direction of the open position thereof via a spring and being switchable electrically into a position in which the relief path is blocked. In the event of a power failure, said relief path is then correspondingly opened so that the spring can relax.

An important requirement imposed on hydraulic switching fitting arrangements of this type consists in the emergency functionality of the adjusting arrangement being able to be checked, substantially without impairment, during the operation. In this case, it should be established whether the emergency actuation is intact and, in the event of a power failure, the process fitting and/or the switching drive can close.

In the case of the regulating drive, said test is possible with a comparatively little outlay, since the emergency functionality can be interrogated by suitable activation of the regulating drive within the context of a part stroke test. However, such a part stroke test cannot be realized with a conventional switching fitting, since the latter can merely be switched between the open position and the closed position via the associated switching drive. Accordingly, checking cannot be undertaken during the operation of the turbine or process engineering installation.

DE 10 2011 104 530 A1 shows a hydraulic switching fitting arrangement, in which a fitting which is prestressed in the direction of a closed position is actuated via an actuator. The actuator, preferably a hydraulic cylinder, has a pressure space which is effective in the opening direction and which is connectable to low pressure via three parallel relief paths. According to the disclosure, a secondary relief path which can be opened in the testing mode is provided.

With such a solution, the emergency function of the switching drive of a switching fitting can be reliably checked by way of a part stroke test. However, it is problematic if two switching drives are switched in parallel or in series, since then, during the checking of the emergency function, both switching drives are switched in an unpressurized manner, for example via the previously described secondary relief path, and therefore both execute a part stroke. As a result, it is difficult to assess whether the emergency function of each individual switching drive is ensured.

By contrast, the disclosure is based on the object of providing a switching fitting arrangement in which the emergency function of two switching drives can be checked.

### SUMMARY

This object is achieved by a switching fitting arrangement having the features of the disclosure.

Advantageous developments of the disclosure are the subject matter of the dependent claims.

According to the disclosure, the switching fitting arrangement for controlling process flows (gas, liquid) has at least two switching fittings which are each actuable by means of an actuator. Said actuator is prestressed by means of an energy accumulator in the direction of a basic position, in which the associated switching fitting is closed. The actuator is acted upon hydraulically with a pressure in order to open the switching fitting counter to the force of the energy accumulator. According to the disclosure, one of the two switching fittings is assigned an additional energy accumulator which is in operative engagement with the actuator in the direction of the position only during a part of the stroke of the actuator in question. After said part stroke has been carried out, only the conventional energy accumulator still acts in the direction of the basic position, preferably the closed position of the switching fitting. If the actuator pressure space which is effective counter to the force of the energy accumulator is then connected to the low pressure, a pressure which corresponds to the force equivalent of the energy accumulator and of the additional energy accumulator is then produced in the pressure space of the actuator connected to the additional energy accumulator. Said pressure outweighs the resetting force of the energy accumulator on the other actuator which is designed without the additional energy accumulator. Accordingly, said actuator initially remains stationary while the actuator provided with the additional energy accumulator moves in the direction of the spring-prestressed basic position. After passing through the part stroke, the additional energy accumulator passes out of engagement. However, during said part stroke, the associated energy accumulator is already discharged somewhat, and therefore the resetting force of the still completely charged energy accumulator of the actuator designed without the additional energy accumulator predominates and accordingly said actuator is moved in the direction of the basic position thereof while the other actuator remains stationary.

It is thereby ensured that the two actuators extend for a certain predetermined distance when the part stroke test is carried out. That is to say, the emergency function of the individual switching drives can be reliably established even in the event of a common secondary relief path.

In a preferred exemplary embodiment of the disclosure, the actuators are designed as switching cylinders while the energy accumulators are switching springs which act upon the switching cylinder in the extension direction.

The additional energy accumulator can be designed as a part stroke spring which, after the part stroke, runs onto a stop, and therefore the further stroke of the actuator is determined by the associated switching spring while the part stroke is determined by the force of the switching spring and of the part stroke spring.

In a particularly preferred variant, the switching spring and the part stroke spring are arranged parallel to each other.

The checking of the emergency function is particularly simple if the switching spring of the two switching fittings have approximately the same spring constant and the same prestressing.

According to the disclosure, it is preferred if the part stroke originates from the inner dead center of the cylinder (retracted cylinder).

In an exemplary embodiment of the disclosure, the switching fitting arrangement is designed with a plurality of relief paths, preferably three parallel relief paths, in which in each case one upstream and one downstream relief valve are consecutively connected. Said relief valves can be adjusted in each case from a blocking position into a relief position in order to close the switching fittings.

The emergency function is tested by means of a secondary relief path which extends between output connections (B) of the upstream or of the downstream relief valves, wherein at least one orifice is arranged in each case between two adjacent relief valves. The relief path furthermore has an activation circuit which is designed in such a manner that an upstream relief valve in one relief path and a downstream relief valve in a different relief path can be adjusted into a relief position in a testing mode.

The design of the switching fitting arrangement is further simplified if the relief valves are designed as pilot controlled logic valves.

According to the disclosure, it is preferred if the spring constant of the switching springs is smaller than that of the part stroke spring.

### BRIEF DESCRIPTION OF THE DRAWINGS

A preferred exemplary embodiment of the disclosure is explained in more detail below with reference to schematic drawings, in which:

FIG. 1 shows a highly simplified circuit diagram with a regulating fitting and a switching fitting arrangement according to the disclosure;

FIG. 2 shows a circuit plan for clarifying the activation of a switching fitting arrangement according to FIG. 1, and

FIG. 3 shows a schematic illustration of the functioning of the switching fitting arrangement according to the disclosure.

### DETAILED DESCRIPTION

The disclosure is explained below with reference to an exemplary embodiment in which a volumetric flow of steam for a steam turbine is intended to be set via a regulating fitting and a switching fitting arrangement 1. Of course, adjusting arrangements of this type can also be used for regulation of a gas turbine or for general process engineering.

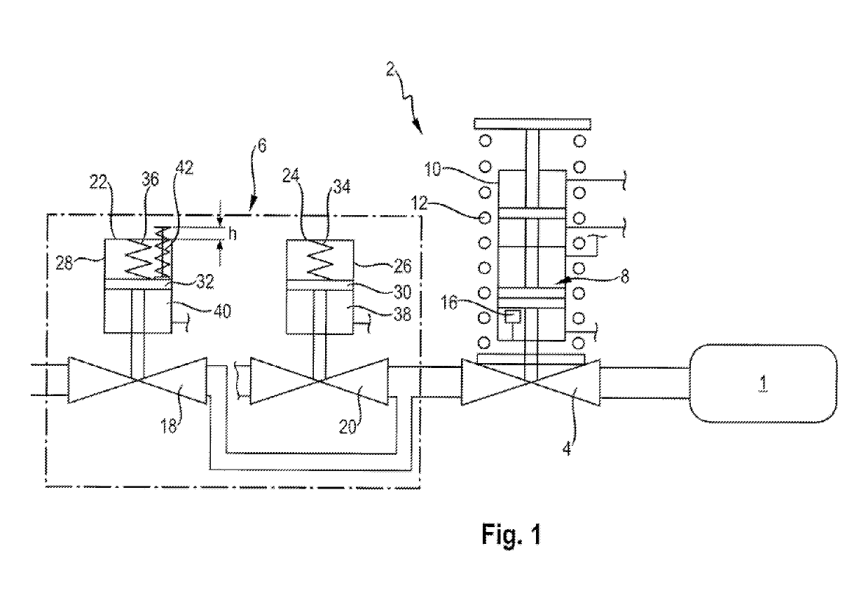

FIG. 1 in this case shows a highly simplified schematic diagram of a steam turbine 1, the volumetric flow of steam of which can be regulated via an adjusting arrangement 2 according to the disclosure with a regulating fitting 4 and a switching fitting arrangement 6 having two switching fittings arranged in parallel in front of the regulating fitting. The regulating fitting 4 is actuated via a regulating drive 8 via which the opening cross section of the regulating fitting 4 can be adjusted proportionally in order to regulate the supply of steam to the steam turbine 1. The regulating drive 8 substantially consists of a regulating cylinder 10 via which a valve body of the regulating fitting 4 can be adjusted. In the event of a malfunction, for example a power failure, the regulating fitting 4 cannot be directly reset via the regulating cylinder 10. In the case of the actuator according to the disclosure, said resetting is undertaken via an emergency actuation 12 which substantially consists of a spring accumulator which is hydraulically prestressed via the regulating cylinder 10. In the event of a power failure, the spring accumulator of the emergency actuation 12 is unlocked, and therefore the regulating fitting 4 is returned into the closed position thereof. In order to avoid excessive acceleration of the regulating fitting 4 in the end position, said regulating fitting is assigned a damping device 16 via which the movement of the fitting is damped in the region of the end position.

With regard to further details of the design of regulating fittings of this type, reference is made to the documents mentioned at the beginning.

The switching fitting arrangement 6 according to the disclosure has two switching fittings 18, 20 which are arranged in parallel and to each of which a switching drive 22, 24 is assigned. The two switching drives 22, 24 are kept in the open position thereof during the regular operation of the steam turbine. In the event of a power failure, the switching fittings 18, 20 are moved via the respectively assigned switching drive 22, 24 into the closed position such that the supply of steam is blocked. In the exemplary embodiment illustrated, each switching drive 22, 24 consists in principle of a switching cylinder 26, 28, the piston 30, 32 of which is prestressed in each case via a switching spring 34, 36 into an extension position in which the associated switching fitting 18, 20 is blocked. An annular space 38, 40 on the piston-rod side is in each case acted upon via a supply of pressure medium with a pressure which is adequate to retract the piston 30, 32 counter to the force of the respective switching spring 34, 36—the switching fitting 18, 20 is then opened. Of course, the piston 30, 32 can also be electrically actuated.

In the event of a malfunction, for example a power failure, the annular space 38, 40 is connected to low pressure, and therefore the associated switching fitting 18, 20 is adjusted into the blocking position thereof by the force of the switching spring 34, 36.

According to the disclosure, the switching drive 22 of the switching fitting 20, 18 is additionally designed with a part stroke spring 42 which is arranged parallel to the switching spring 36 and acts upon the piston 32 in the direction of the closed position thereof. However, said part stroke spring 42 is effective only during a part stroke h starting from the upper dead center (switching spring 36 and part stroke spring 42 completely stressed). As explained below, after passing through the part stroke h the part stroke spring 42 runs onto a stop, and therefore the further closing movement of the piston 32 is determined by the force of the switching spring 36 and the pressure in the annular space 40.

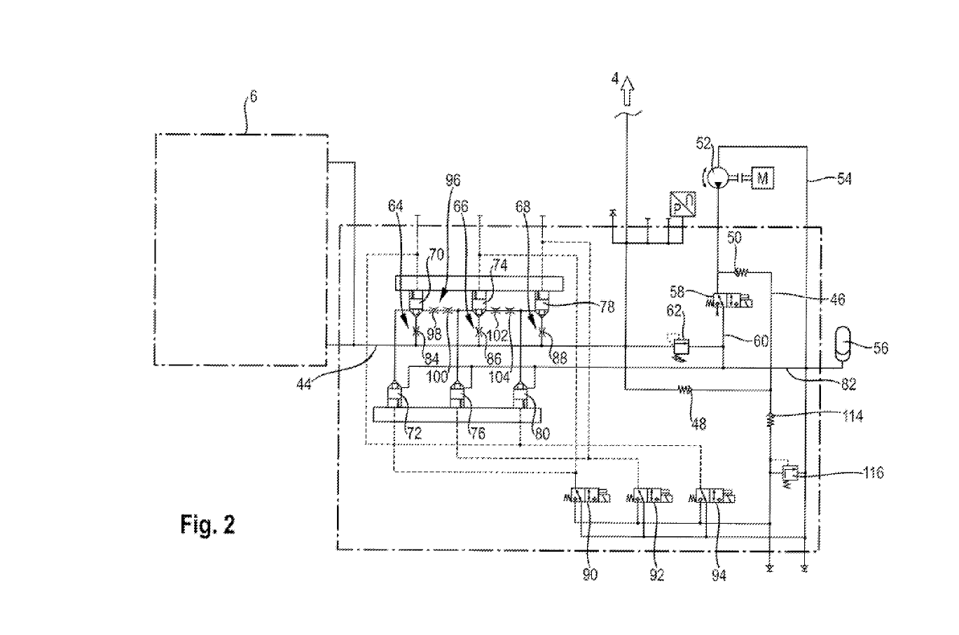

FIG. 2 shows a circuit plan from which the activation of the two switching drives 22, 24 of the switching fitting arrangement 6 can be gathered. The basic design of said circuit is explained in the prior art described at the beginning, and therefore only the basic function is explained here. In the solution illustrated, the two switching drives 22, 24 of the switching fitting arrangement 6 are assigned a common circuit via which the two annular spaces 38, 40 can be acted upon with a pressure in order to bring the switching fittings 18, 20 into the open position thereof. When the pressure in the annular spaces 38, 40 is relieved, the springs 34, 36, 42 explained with reference to FIG. 1 become effective, and therefore the switching fittings 18, 20 are moved into the closed position thereof. The two annular spaces 38, 40 are connected to a main line 44 which, for its part, opens into a supply line 46, wherein the main line 44 is provided with a nonreturn valve 48 which permits a flow of pressure medium in the direction of the switching fitting arrangement 6 and blocks a flow of pressure medium in the direction of the supply line 46. The latter is connected via a further nonreturn valve 48 to the delivery connection of a switching pump 52, the intake connection of which is connected to a low-pressure accumulator 56 via a suction line 54. The supply line 46 branches toward the connection A of a low-pressure valve 58 which, in the spring-prestressed basic position thereof, connects the working connection A to a tank connection T which, for its part, is connected to a tank line 60 which opens into the suction line 54. The pressure in the supply line 44 is limited via a pressure-limiting valve 62.

The low-pressure valve 58 can be adjusted into a switching position in which the connection of pressure medium to the tank line 60 is blocked. In the exemplary embodiment illustrated, the low-pressure valve is designed as a seat valve.

The two annular spaces 38, 40 can be connected to the low-pressure accumulator 56 via a total of three relief paths 64, 66, 68 in order to close the switching fittings 18, 20. Two relief valves 70, 72; 74, 76; 78, 80 which are connected in series are arranged in each of the relief paths 64, 66, 68, via which relief valves a pressure medium connection from the main line 44 to an outlet line 82, which is connected to the low-pressure accumulator 56, can be opened. Said outlet line opens into the suction line 54. Each of the relief valves 70, 72, 74, 76, 78, 80 is designed as a logic valve. The three relief valves 70, 74, 78 are connected via the connections A thereof to the main line 44 via one orifice 84, 86, 88 each. Radial connections B of the relief valves 70, 74, 78 are connected to the connections A of the relief valves 72, 76, 80. The radial connections B of said relief valves 70, 74, 78 are then, for their part, connected to the outlet line 82. The relief valves 70 to 80 are prestressed in the direction of the closed position thereof via a comparatively weak spring. A pressure which is determined via relief control valves 90, 92, 94 assigned to one relief path 64, 66, 68 each acts in control spaces of the relief valves. Said relief control valves are designed in each case as 3/2-way seat valves and are prestressed via a spring into a basic position in which a control connection A is in each case connected to a tank connection T which, for its part, is in pressure medium connection with the low-pressure accumulator 56. Each of the relief valves 90, 92, 94 can be electrically connected into a position in which the connection A is connected to a delivery connection P which, for its part, is in pressure medium connection with the supply line 46 and therefore with the delivery connection of the switching pump 52. The control connection A of the relief control valve 90 is connected via control lines to the control spaces of the relief valves 72 and 74. The control connection A of the relief control valve 92 is connected via control lines to the control spaces of the relief valves 76 and 78. The control connection of the third relief control valve 94 is then correspondingly connected to the control spaces of the relief valves 70 and 80. In other words, relief valves placed in different relief paths are acted upon with low pressure or high pressure (pumping pressure) via one relief control valve 90, 92, 94 each. This forms a hydraulic “2-out-of-3-circuit” which ensures that correct closing is provided for even in the event of failure of one of the relief control valves 90, 92, 94 or of the associated relief valves 70 to 80.

In the event of a power failure, the relief control valves 90, 92, 94 are adjusted by the force of the respective switching spring thereof into the basic position thereof, in which the respective relief flow path is opened in the direction to the low-pressure accumulator 56 such that the pressure medium flows out of the two annular spaces 38, 40 via the three above-described relief paths 64, 66, 68, and therefore the switching fittings are switched over into the blocking position thereof by the force of the springs 34, 36, 42.

The functionality of the switching fitting arrangement 6 according to the disclosure is intended to be able to be checked via a part stroke test.

In order to permit such a part stroke test, the output connections B of the relief valves 70, 74, 78 arranged upstream (as seen in the direction of pressure relief) are connected to one another via a secondary relief path 96, wherein two series-connected nozzles 98, 100 and 102, 104 are arranged in each case between two adjacent relief valves 70, 74, 78. Said nozzles have a comparatively small opening cross section. However, the latter is of a size sufficient to be able to prevent clogging of the nozzles by impurities contained in the pressure medium. On the other side, the pressure loss via the two nozzles 98, 100; 102, 104 which are connected consecutively is of such a size that only little pressure medium can flow off. Flow-regulating valves can optionally also be used instead of the nozzles. A nonreturn valve 114 is arranged in the supply line 46, said nonreturn valve preventing an invasion of pressure upstream of the relief valves 90, 92, 94 via the nonreturn valve 48 during switching operations.

The reference number 116 identifies a pressure-limiting valve which, in the event of an increase in temperature, prevents a pressure rise in the relief line 46 by opening to the intake line 54.

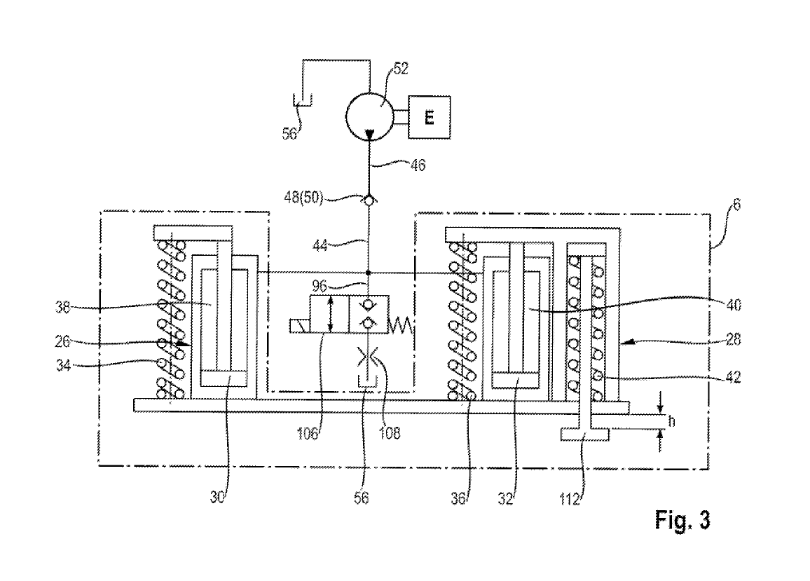

For the part stroke test, one of the relief control valves 90, 92, 94 is switched over into the basic position thereof, in which the respective connection A is connected to the tank connection T. If, for example, the relief control valve 90 is brought into the basic position thereof, which is illustrated in FIG. 2, and the two other relief control valves 92, 94 are switched over into the switching position thereof by energizing of the switching magnets, the control spaces of the two relief valves 72, 74 are relieved towards the low-pressure accumulator 56 while the other relief valves 70, 76, 78, 80 remain in the blocking position thereof. As explained in more detail below with reference to FIG. 3, by means of said switching-over operation, the two annular spaces 38, 40 are connected to the low-pressure accumulator 56 via the main line 44, the orifice 86, the opened relief valve 74, the two nozzles 98, 100 of the secondary relief path 96 and via the likewise opened, downstream relief valve 72 and the outlet line 82.

Further details are explained with reference to FIG. 3. In this illustration, the switching drive and the associated hydraulic circuit for actuating the switching fitting arrangement 6 are reproduced in extremely highly simplified form, wherein the actual switching fittings 18, 20 are not illustrated. FIG. 3 illustrates the above-described switching pump 52 which takes in pressure medium from a low-pressure accumulator 56 or a tank. As explained, the delivery connection is connected via the supply line 46 and the nonreturn valve 48 or 50 to the main line 44 which branches and opens into the annular spaces of the switching cylinders 26, 28. The function of the relief paths and the relief valves arranged therein and of the secondary relief path 96 with the associated nozzles is reproduced by a valve and a nozzle, which are referred to below as valve 106 and throttle 108. In the spring-prestressed basic position thereof corresponding to the basic position of the above-described relief valves 70 to 80, the pressure medium connection to the tank or low-pressure accumulator 56 is blocked without leakage. The relief path or the secondary relief path 96 is opened by switching over the valve 106 such that the pressure medium connection of the two annular spaces 38, 40 to the low-pressure accumulator 56 (tank) is opened, with the throttle 108 limiting the volumetric flow of pressure medium.

As indicated in FIG. 3, the piston 30 of the switching cylinder 26 is acted upon in the direction of the extension position thereof merely via the switching spring 34 (associated switching fitting 18 blocked). By means of the pressure medium connection of the annular space 38 to the delivery connection of the switching pump 52, the piston 30 is retracted into the illustrated position thereof counter to the force of the switching spring 34—the associated switching fitting 20 is then opened. As already explained, the switching cylinder 28 of the other switching fitting 18 is likewise formed with a switching spring 36, the spring constant of which corresponds, for example, to that of the switching spring 34. Parallel to said switching spring 36, the piston 32 is acted upon in the direction of the extension position thereof by the force of the part stroke spring 42. However, said part stroke spring 42 is effective from the illustrated inner dead center only during a part stroke h. After passing through said part stroke h, a stop 112 becomes effective, said stop preventing further expansion of the part stroke spring 42 and therefore the operative engagement thereof with the piston 32. That is to say, after passing through the part stroke h, the extension movement of the piston 32 is only still substantially influenced by the force of the switching spring 36 and the corresponding pressure in the annular space 40.

As explained at the beginning, when the valve 106 is switched over (correspondingly opening the secondary relief path according to FIG. 2), both the annular space 40 and the annular space 38 are connected to the tank or low-pressure accumulator 56 via the throttle 108. The pressure in the annular spaces 38, 40 then initially corresponds to the force equivalent of the switching spring 36 and of the additional part stroke spring 42. This pressure outweighs the resetting force of the switching spring 34 on the switching cylinder 26, and therefore the latter initially remains in the retracted position thereof. Accordingly, the piston 32 of the switching cylinder 28 extends until, after passing through the part stroke h, the stop 112 becomes effective. That is to say, the part stroke spring 42 passes out of engagement. After passing through said part stroke h, the other piston 30 of the switching cylinder 26 is still in the retracted position thereof. The force of the switching spring 34 which is accordingly still completely stressed then outweighs the force of the already somewhat relaxed switching spring 36 of the other switching cylinder 28, and therefore the piston 32 thereof remains stationary and the piston 30 of the switching cylinder 26 extends, wherein the pressure drops to the equivalence value which approximately corresponds to the force of the switching spring 34.

Accordingly, the extension movement of the two pistons 30, 32 of the switching cylinders 26, 28 is undertaken sequentially such that a part stroke test can be carried out in a simple manner. As soon as the prestressing of the switching spring 34 has dropped to the value which the switching spring 36 which is already relaxed has, the two switching cylinders 26, 28 move synchronously—and the part stroke test is finished.

The function will be explained once again with reference to a specific arithmetic example. Let it be assumed that the spring force of the switching spring 34 is approximately 36,300 N when the piston 30 is completely retracted. The spring constant of the switching spring 34 is intended to be 50 N/mm. The internal friction of the switching cylinder 26 is assumed at 1100 N.

When the cylinder is retracted, the spring force of the switching spring 36 of the switching cylinder 28 is intended to be 36,100 N. The spring constant of said switching spring 36 is likewise 50 N/mm The internal friction is assumed at 850 N.

When the piston 32 is completely retracted, the spring force of the part stroke spring 42 is assumed at 3200 N. The spring constant of said part stroke spring 42 is intended to be 320 N/mm The stroke h of the spring is 5 mm.

The balance of forces when opening the valve 106 (stroke=0.00 mm) is then as follows: the full spring force minus the internal friction of the cylinder acts on the piston 30 of the switching cylinder 26, i.e. a force of 35,200 N is in effect. The spring force of the switching spring 36 plus the force of the part stroke spring 42 minus the internal friction acts on the other switching cylinder 28, i.e. a force of 38,450 N is in effect. Correspondingly, first of all the piston 32 of the switching cylinder moves, and the piston 30 remains stationary.

After a stroke of, for example, 5 mm, the balance of forces appears approximately as follows: the same force of 35,200 N still continues to act on the switching cylinder 30, since the piston 30 has not moved. A force which has been reduced in relation to the starting situation by the relaxation of the two springs 36, 42 acts on the switching cylinder 28; accordingly, the spring force is calculated according to 36,100 N−5 mm×50 N/mm+3,200 N−5 mm×320 N/mm−850 N=36,600 N. That is to say, after 5 mm, the force effective on the piston 32 still continues to predominate, and therefore said piston is moved further while the piston 30 remains stationary.

After a stroke of 5.01 mm, i.e. after passing through the part stroke h, the force applied via the part stroke spring 42 is dispensed with, and therefore the spring force effective on the piston 32 of the switching cylinder 28 is calculated according to the equation:

36,100 N−5.01 mm×50 N/mm−850 N=35,000 N

Accordingly, the piston 30 of the switching cylinder 26 then moves while the piston 30 of the switching cylinder 28 remains stationary.

After a stroke of 4 mm of the piston 30, the same spring forces act on the two pistons 30, 32, and therefore the two pistons 30, 32 extend synchronously, with the switching cylinder 28 having a projection of 1 mm.

By means of the switching fitting arrangement according to the disclosure with two switching drives, a part stroke test is made possible by establishing the switching sequence by just one 2 of 3 triggering operation. In this case, two switching drives can be designed in each case with one switching valve or each switching fitting can be designed with one switching drive.

A switching fitting arrangement with two switching fittings which are each actuated by a switching drive is disclosed. A switching drive is designed with an additional energy accumulator, for example a part stroke spring, which permits a part stroke test.
LIST OF REFERENCE NUMBERS:
1 Steam turbine
2 Adjusting arrangement
4 Regulating fitting
6 Switching fitting arrangement
8 Regulating drive
10 Regulating cylinder
12 Emergency actuation
16 Damping device
18 Switching fitting
20 Switching fitting
22 Switching drive
24 Switching drive
26 Switching cylinder
28 Switching cylinder
30 Piston
32 Piston
34 Switching spring
36 Switching spring
38 Annular space
40 Annular space
42 Part stroke spring
44 Main line
46 Supply line
48 Nonreturn valve
50 Further nonreturn valve
52 Switching pump
54 Suction line
56 Low-pressure accumulator/tank
58 Low-pressure valve
60 Tank line
62 Pressure-limiting valve
64 Relief path
66 Relief path
68 Relief path
70 Relief valve
72 Relief valve
74 Relief valve
76 Relief valve
78 Relief valve
80 Relief valve
82 Outlet line
84 Orifice
86 Orifice
88 Orifice
90 Relief control valve
92 Relief control valve
94 Relief control valve
96 Secondary relief path
98 Nozzle
100 Nozzle
102 Nozzle
104 Nozzle
106 Valve
108 Throttle
112 Stop
114 Nonreturn valve
116 Pressure-limiting valve

What is claimed is:

1. A switching fitting arrangement for controlling process flows, comprising:
an actuator; and
at least two switching fittings actuated by the actuator, the actuator being (i) prestressed via an energy accumulator in the direction of a basic position in which the associated switching fitting is closed and (ii) configured to be acted upon hydraulically with a pressure to open the switching fitting counter to the force of the energy accumulator,
wherein one of the switching fittings is assigned an additional energy accumulator operatively engaged in the direction of the basic position only during a part stroke of the actuator.

2. The switching fitting arrangement according to claim 1, wherein the actuator is a switching cylinder and the energy accumulator is a switching spring which acts upon the switching cylinder in the extension direction.

3. The switching fitting arrangement according to claim 2, wherein the additional energy accumulator is a part stroke spring which runs onto a stop after the part stroke, wherein the further stroke of the actuator is substantially determined by the switching spring, and wherein the extension movement during the part stroke is determined jointly by the force of the switching spring and the part stroke spring.

4. The switching fitting arrangement according to claim 3, wherein the switching spring and the part stroke spring are arranged in parallel.

5. The switching fitting arrangement according to claim 2, wherein the switching springs of the two switching fittings have approximately the same spring constant.

6. The switching fitting arrangement according to claim 1, wherein the part stroke originates from an inner dead center of the switching cylinder.

7. The switching fitting arrangement according to claim 1, further comprising a plurality of relief paths, the relief paths each having one upstream and one downstream relief valve connected consecutively and configured to be brought into a relief position to close the switching fittings.

8. The switching fitting arrangement according to claim 7, further comprising:
a secondary relief path which extends between output connections of the upstream or the downstream relief valves and in which at least one nozzle is respectcively arranged between two adjacent relief valves, and
an activation circuit which is configured in such a manner that an upstream relief valve in one relief path and a downstream relief valve in a different relief path are configured to be adjusted into a relief position in a testing mode.

9. The switching fitting arrangement according to claim 7, wherein the relief valves are logic valves.

10. The switching fitting arrangement according to claim 3, wherein the spring constants of the switching springs are smaller than that of the part stroke spring.

11. The switching fitting arrangement according to claim 7, wherein the plurality of relief paths are three parallel relief paths.
